(19) United States
(12) Patent Application Publication
(10) Pub. No.: US 2006/0022906 A1
(43) Pub. Date: Feb. 2, 2006

(54) Method and device for driving display panel

(75) Inventors: Jun Kamiyamaguchi, Nakakoma-gun (JP); Akira Gotoda, Yamanashi-ken (JP); Tetsuya Shigeta, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/171,491

(22) Filed: Jul. 1, 2005

(30) Foreign Application Priority Data
Jul. 1, 2004 (JP) 2004-195988

(51) Int. Cl. G09G 3/28

(52) U.S. Cl. 345/63

(57) ABSTRACT

Disclosed is a method of driving a display panel for displaying a halftone image of each of fields constituting a video signal, each field being composed of a plurality of subfields. This method detects a luminance distribution of the video signal, divides each of the fields into a first subfield group comprised of N subfields and a second subfield group comprised of M subfields (N, M are integers equal to or more than one), and displays the first subfield group with 2^{N} gradation levels and the second subfield group with (M+1) gradation levels. The numbers N, M of subfields respectively allocated to the first and second subfield groups are set in accordance with the luminance distribution.

### BACKGROUND OF THE INVENTION

1. Field of the Invention

The present invention relates to a method and device for driving a display panel in a display such as a plasma display.

2. Description of the Related Art

The plasma display has a plurality of discharge cells arranged in a matrix, and emits light by exciting a fluorescent material in selected discharge cells with ultraviolet rays generated by gas discharges produced in the selected discharge cells. The plasma display can display with multiple luminance levels by controlling the number of times of discharges in the discharge cells in a unit time, i.e., by controlling the number of discharge sustain pulses applied to the discharge cells. A driving method widely employed for the plasma display is a subfield method which divides one field corresponding to one image into a plurality of subfields, sets ratios of light emission sustain periods assigned to the respective subfields to powers of two, and displays a halftone image with a combination of these subfields. For example, when the ratios of the light emission sustain periods of eight subfields SF₁, SF₂, . . . , SF₈ is set to 2⁰:2¹:2²:2³:2⁴:2⁵:2⁶:2⁷, i.e., 1:2:4:8:16:32:64:128, 256 different gradation levels can be generated by combinations of the subfields. Related art of the subfield method is disclosed, for example, in Japanese Patent Kokai No. 2004-4606.

When a plasma display displays a moving-video image in accordance with the subfield method, noises referred to as a so-called “dynamic false contour” remarkably deteriorates moving image quality. This problem is well known in the art. A driving method for preventing occurrence of such dynamic false contour is known from Japanese Patent Kokai No. 2000-227778. This driving method has an advantage of basically avoiding the occurrence of the dynamic false contour mentioned above because light emission patterns of the subfields temporally and spatially continue within one field during a display period. However, this driving method has a disadvantage in that the number of feasible gradation levels is small.

### SUMMARY OF THE INVENTION

In view of the foregoing, it is an object of the present invention to provide a method and device for driving a display panel which are capable of representing a large number of gradation levels and largely reducing the occurrence of the dynamic false contour.

According to one aspect of the present invention, there is provided a method of driving a display panel for displaying a halftone image of each of fields constituting a video signal, each field being composed of a plurality of subfields. This method comprises the steps of: (a) detecting a luminance distribution of the video signal; (b) dividing each of the fields into a first subfield group comprised of N subfields (where N is an integer equal to or more than one), and a second subfield group comprised of M subfields (where M is an integer equal to or more than one); (c) displaying the first subfield group with 2N gradation levels on the display panel; and (d) displaying the second subfield group with (M+1) gradation levels on the display panel, wherein at the step (b), the number N of subfields allocated to the first subfield group and the number M of subfields allocated to the second subfield group are set in accordance with the luminance distribution.

According to another aspect of the present invention, there is provided a device for driving a display panel for displaying a halftone image each of fields constituting a video signal, each field being composed of a plurality of subfields. This device comprises a luminance distribution detector for detecting a luminance distribution of the video signal; a subfield allocation part for dividing each of the fields into a first subfield group comprised of N subfields (N is an integer equal to or more than one), and a second subfield group comprised of M subfields (M is an integer equal to or more than one); and a driving unit for driving the display panel to display the first subfield group with 2^{N} gradation levels and the second subfield group with (M+1) gradation levels, wherein the subfield allocation part sets the number N of subfields allocated to the first subfield group and the number M of subfields allocated to the second subfield group in accordance with the luminance distribution.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram schematically showing a configuration of a plasma display which is an embodiment of the present invention;

FIG. 2 is a plan view of a partial region of a display panel;

FIG. 3 is a cross-sectional view taken along a 3-3 line of the display panel shown in FIG. 2;

FIG. 4 is a diagram showing an example of a light emission driving format according to a second gradation driving scheme;

FIG. 5 is a timing chart schematically showing waveforms of pulses applied to the display panel in accordance with the light emission driving format shown in FIG. 4;

FIG. 6 is a diagram illustrating a correspondence relationship between gradation levels and field data according to the second gradation driving scheme, and light emission patterns;

FIG. 7 is a diagram showing an example of a light emission driving format according to a first gradation driving scheme;

FIG. 8 is a diagram illustrating a correspondence relationship between gradation levels and field data according to the first gradation driving scheme, and light emission patterns;

FIG. 9A is a diagram showing a luminance histogram in which a luminance distribution of a video signal is localized in a low luminance region;

FIG. 9B is a diagram showing a luminance histogram in which a luminance distribution is localized in an intermediate luminance region;

FIG. 9C is a diagram showing a luminance histogram in which a luminance distribution is localized in a high luminance region;

FIGS. 10A and 10B are diagrams schematically showing input/output characteristics of a data converter, respectively;

FIG. 11 is a diagram illustrating a light emission driving format when a luminance distribution of a video signal is localized in a low luminance region;

FIG. 12 is a diagram showing a conversion table and light emission patterns corresponding to the light emission driving format shown in FIG. 11;

FIG. 13 is a diagram illustrating a light emission driving format when a luminance distribution of a video signal is localized in a high luminance region or intermediate luminance region;

FIG. 14 is a diagram showing a conversion table and light emission patterns corresponding to the light emission driving format shown in FIG. 13;

FIG. 15 is a diagram showing an example of a conversion table and light emission patterns according to a first exemplary modification;

FIG. 16 is a diagram showing an example of a conversion table and light emission patterns according to a second exemplary modification;

FIG. 17 is a diagram showing an example of a conversion table and light emission patterns according to a third exemplary modification; and

FIG. 18 is a diagram illustrating an arrangement of subfields.

### DETAILED DESCRIPTION OF THE INVENTION

Various embodiments of the present invention will be described below.

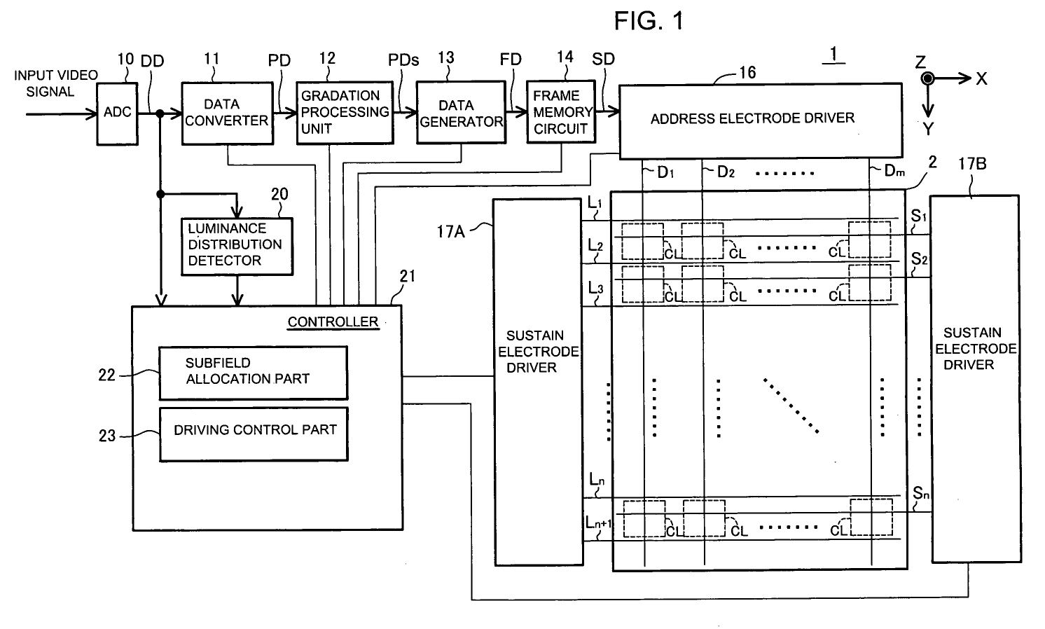

FIG. 1 is a block diagram schematically showing a plasma display (display device) which is an embodiment of the present invention. This plasma display 1 comprises a display panel (plasma display panel) 2, and an address electrode driver 16 and sustain electrode drivers 17A, 17B for driving the display panel 2. The plasma display 1 further comprises an A/D converter (ADC) 10, a data converter 11, a gradation processing unit 12, a data generator 13, a frame memory circuit 14, a luminance distribution detector 20, and a controller 21. The controller 21 controls the processing blocks 11, 12, 13, 14, 16, 17A, 17B.

An input video signal is composed of R (red), G (green), B (blue) analog signals, and the A/D converter 10 samples and quantizes, for example, the R, G, B analog signals, respectively, to generate R, G, B digital video signals DD which are supplied to the data converter 11, luminance distribution detector 20, and controller 21. The data converter 11 performs gamma-conversion on the digital video signals DD in accordance with a characteristic curve previously stored therein, and outputs a K-bit corrected video signal PD (K is an arbitrary integer equal to or less than a set value) to the gradation processing unit 12 in response to an instruction of the controller 21. The data converter 11 can perform inverse-gamma-correction on the digital video signal DD of 8-bit gradation (i.e., 2⁸ gradation levels) to output a corrected video signal PD of 1-bit gradation to 10-bit gradation (i.e., 2¹-2¹⁰ gradations).

The gradation processing unit 12 applies error diffusion processing or dither processing to the corrected video signal PD input from the video converter 11 to produce a video signal PDs which is output to the data generator 13. For example, given an L-bit (L is a positive integer) corrected video signal PD input from the data converter 11, the gradation processing unit 12 executes the error diffusion processing which diffuses lower x bits (x is a positive integer less than L) of the corrected video signal PD to upper L-x bits of signals of surrounding pixels, then adds elements of a dither matrix to the (L-x)-bit signal produced through the error diffusion processing, and shifts the resulting signal to the right to output upper L-y bits (y is a positive integer less than L-x) of video signal PDs. The elements of the dither matrix have been previously stored in a memory (not shown).

The data generator 13 generates field data FD from the video signal PD input from the gradation processing unit 12, and outputs the field data FD to the frame memory circuit 14. The frame memory circuit 14 temporarily stores the input field data FD in an internal buffer memory (not shown), and reads data stored in the buffer memory in units of subfields and supplies the address electrode driver 16 with the read data. The address electrode driver 16 generates address pulses based on data SD input from the frame memory circuit 14, and applies the address pulses to address electrodes D₁-Dₘ at predetermined timings.

The display panel 2 comprises a plurality of discharge cells CL arranged in a planar matrix shape; m address electrodes D₁, . . . , Dₘ extending in a Y-direction from the address electrode driver 16 (m is an integer equal to or more than two); n+1 sustain electrodes L₁, . . . , Lₙ₊₁ extending in an X-direction perpendicular to the Y-direction from the first sustain electrode driver 17A (n is an integer equal to or more than two); and n sustain electrodes S₁, . . . , Sₙ extending in a -X-direction from the second sustain electrode driver 17B. The discharge cells CL are formed in regions near intersections of the address electrodes D₁-Dₘ with the sustain electrodes L₁-Lₙ₊₁, S₁-Sₙ.

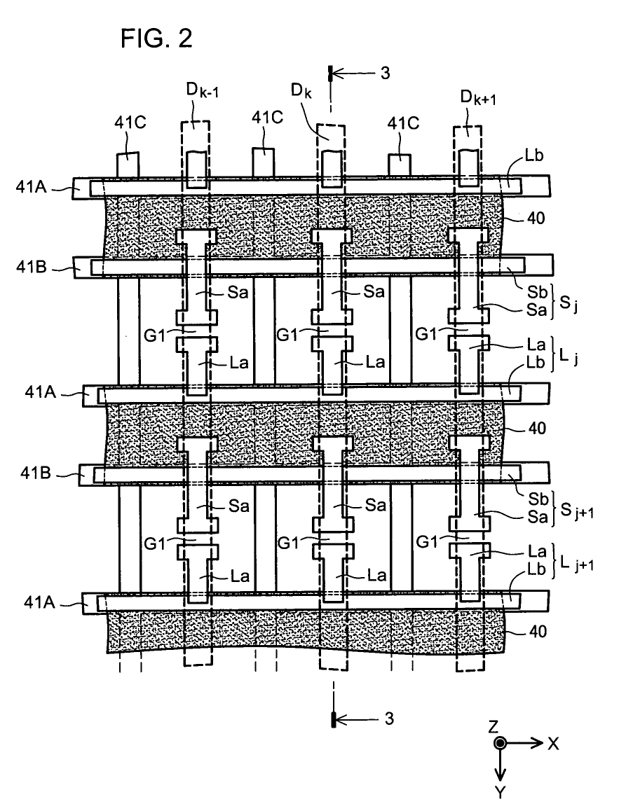

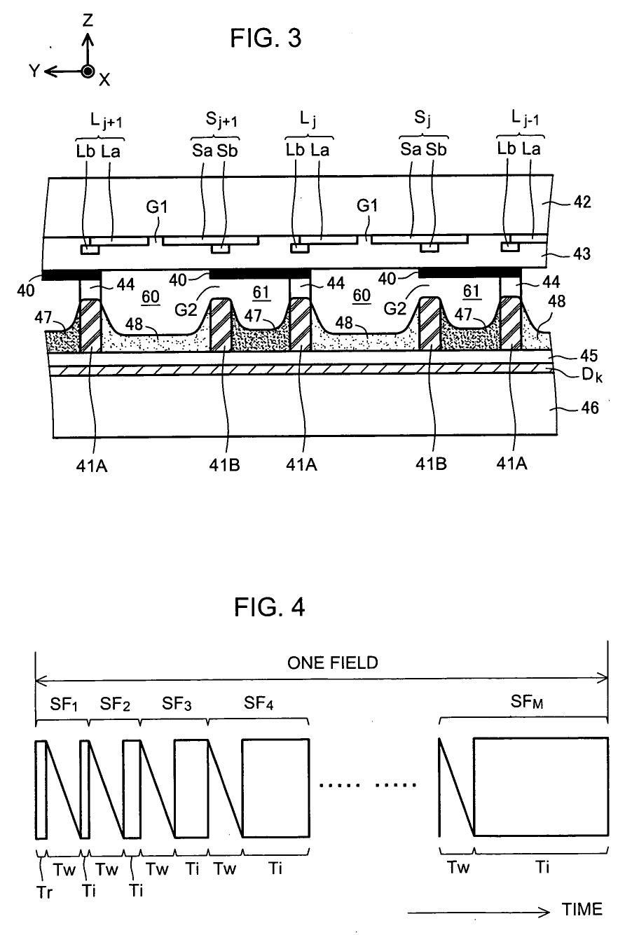

FIG. 2 is a plan view of a partial region of the display panel 2. FIG. 3 is a cross-sectional view taken along a 3-3 line of the display panel 2 shown in FIG. 2. Referring to FIG. 2, each of the sustain electrodes Sⱼ, Sⱼ₊₁ (j is an integer from 1 to n−1) is composed of a strip-shaped bus electrode Sb extending in the -X-direction, and a strip-shaped transparent electrode Sa connected to the bus electrode Sb and extending in the Y-direction. The transparent electrode Sa is made of a transparent conductive material such as ITO (Indium Tin Oxide), and has both ends in a T-shape. The bus-electrode Sb in turn is made of a black or a dark metal film. Each of the sustain electrodes Lⱼ, Lⱼ₊₁ is composed of a strip-shaped bus electrode Lb extending in the X-direction and made of a black or a dark metal film, and a strip-shaped transparent electrode La connected to the bus electrode Lb and extending in the Y-direction. The transparent electrode La, which is made of a transparent conductive material such as ITO, has a leading end in a T-shape which opposes one leading end of the transparent electrode Sa across a discharge gap G1. As shown in FIG. 3, these sustain electrodes Sⱼ, Sⱼ₊₁, Lⱼ, Lⱼ₊₁ are formed on the back surface of a optically transparent front substrate 42, and a front dielectric layer 43 is deposited to cover the sustain electrodes Sⱼ, Sⱼ₊₁, Lⱼ, Lⱼ₊₁. Formed on the front dielectric layer 43 are light-absorbing dielectric layers (black stripe) 40, in stripes, including a black or a dark pigment and extending in the X-direction. A protection film (not shown) made of MgO (magnesium oxide) is formed on the back surfaces of the front dielectric layer 43 and black stripe 40.

On the back substrate 46 opposing the front substrate 42, in turn, strip-shaped address electrodes Dₖ₋₁, Dₖ, Dₖ₊₁ (k is an integer from one to m-1) are deposited to extend in the Y-direction. As shown in FIG. 2, each of the address electrodes Dₖ₊₁, D, Dₖ₊₁ is arranged to oppose a pair of transparent electrodes Sa, SLa in a Z-direction (depth direction of the front substrate 42). Referring to FIG. 3, a back dielectric layer (protection layer) 4 is formed to cover and protect these address electrodes Dₖ₋₁_{, D}ₖ, Dₖ₊₁, and ribs 41A, 41B, 441C are disposed on the back dielectric layer 45 to continue on an X-Y plane. First ribs 51A are arranged in stripes along the X-direction immediately below the bus electrodes Lb, respectively, while second ribs 41B are arranged in stripes along the X-direction immediately below the bus electrodes Sb, respectively. A dielectric material 44 is laminated between the first ribs 41A and the black stripes 40. Third ribs 41C are arranged on the back dielectric layer 45 to define each space on the address electrode in the X-direction. As shown in FIG. 3, a main discharge space 60 is formed between a pair of transparent electrodes La, Sa and the address electrode Dₖ by the ribs 41A, 41B, 41C, and a sub-discharge space 61 is formed between the leading end of the transparent electrode Sa and the address electrode Dₖ. The main discharge space 60 and sub-discharge space 61 communicate with each other through a gap G2 between the black stripe 40 and the second rib 41B. Also, the main discharge space 60 and sub-discharge space 61 are filled with a discharge gas such as Xe (xenon) which generates ultraviolet rays through a discharge.

Formed on the inner wall of the sub-discharge space 61 is an electron emission layer 47 made of a secondary electron emission material having a relatively low work function, for example, MgO (magnesium oxide), BaO (barium oxide) or the like. The inner wall of the main discharge space 60 is coated with a fluorescent layer 48 which receives ultraviolet rays generated through a gas discharge to emit light in red (R), green (G), or blue (B). The discharge cells CL shown in FIG. 1 correspond to areas defined by the first ribs 41A and third ribs 41C, where each discharge cell CL has one main discharge space 60 and one sub-discharge space 61. The foregoing is a description made for the structure of the display panel 2.

Referring to FIG. 1, the controller 21 includes a subfield allocation part 22 and a driving control part 23. The driving unit of the present invention includes the controller 21, address electrode driver 16, and sustain electrode drivers 17A, 17B. As will be described later, the subfield allocation part 22 divides each of fields, which make up a video signal, into a first subfield group and a second subfield group. The number of subfield allocated to the first subfield group, and the number of subfields allocated to the second subfield group can be set in real time in accordance with a localized luminance distribution of a video signal DD. Further, the driving control part 23 supports a plurality of gradation driving schemes, and therefore controls in accordance with a first gradation driving scheme in a period for displaying the first subfield group on the display panel 2, and controls in accordance with a second gradation driving scheme in a period for displaying the second subfield group on the display panel 2.

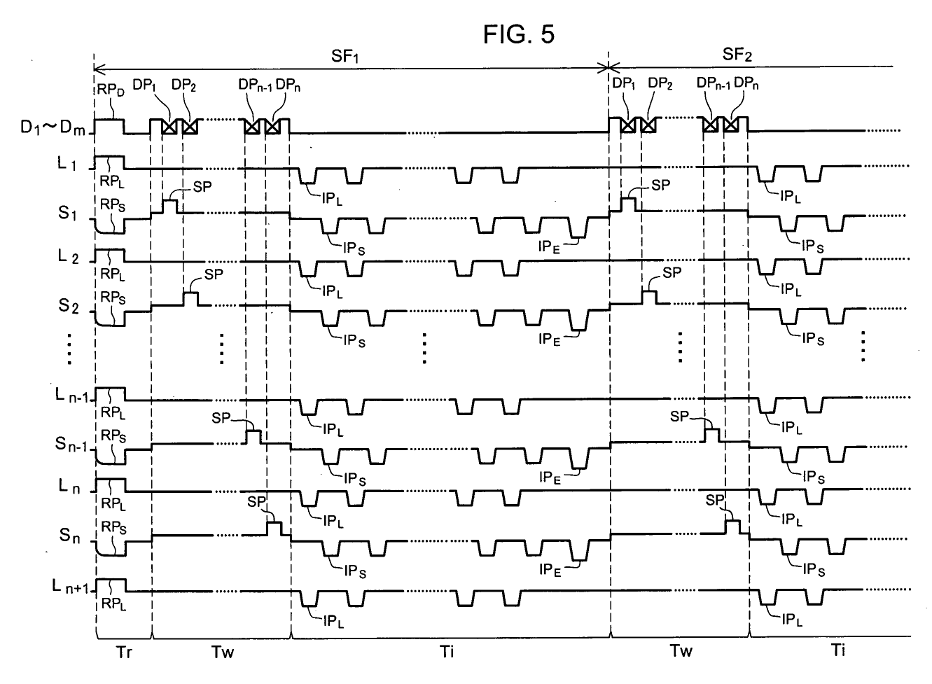

First, the second gradation driving scheme will be described. FIG. 4 shows an example of a light emission driving format in accordance with the second gradation driving scheme, and FIG. 5 is a timing chart schematically showing waveforms of pulses applied to the display panel 2 in accordance with the light emission driving scheme shown in FIG. 4.

Referring to FIG. 4, one field of a video signal is divided into M subfields SF₁-SF_{M} (M is an integer equal to or more than one) arranged in sequence in a displaying order, where each of the subfields SF₁-SF_{M} has an address period Tw and a light emission sustain period Ti. The first subfield SF₁ alone has a reset period Tr immediately before the address period Tw. Also, the subfields SF₁, SF₂, SF₃, . . . , SF_{M} are assigned light emission sustain periods Ti which are proportional to 2⁰, 2¹, 2², . . . , 2^{M}, respectively.

Referring to FIG. 5, in the reset period Tr of the first subfield SF₁, the first sustain electrode driver 17A applies reset pulses RP_{L} of positive polarity to the sustain electrodes L₁, . . . , Lₙ₊₁, respectively, while the second sustain electrode driver 17B applies reset pulses RP_{S} of negative polarity to the sustain electrodes S₁, . . . , Sₙ, respectively, and the address electrode driver 16 applies reset pulses RP_{D} of positive polarity to the address electrodes D₁, . . . , Dₘ, respectively. In this reset period, a gas discharge (reset discharge) is produced in the discharge spaces 60, 61 between the transparent electrode Sa and the address electrode Dₖ of the display panel 2 shown in FIG. 3, and charges generated in the sub-discharge space 61 moves into the main discharge space 60 through the gap G2. As a result, in each of all the discharge cells CL, a wall charge is accumulated on the surface of the fluorescent layer 48 in the main discharge space 60, thus setting all the discharge cells CL to a light emitting mode.

In the next address period Tw, erasure address discharges are selectively produced in discharge cells CL to be extinguished to annihilate the wall charges. Specifically, as shown in FIG. 5, the second sustain electrode driver 17B sequentially applies a scanning pulse SP of positive polarity to the address electrodes D₁, . . . , Dₘ. In this event, the address electrode driver 16 sequentially applies address pulse groups DP₁, . . . , DPₙ in synchronism with the timing at which each scanning pulse SP is applied. Specifically, the address electrode driver 16 applies the address electrodes D₁-Dₘ with the address pulse group DP₁ synchronized to the scanning pulse SP applied to the sustain electrodes S₁ on the first line, and subsequently applies the address electrodes D₁-Dₘ with the address pulse group DP₂ synchronized to the scanning pulse SP applied to the sustain electrode S₂ on the second line. The address electrode driver 16 repeatedly executes such processing until it applies the address pulse group DPₙ synchronized to the scanning pulse SP applied to the sustain electrodes Sₙ on the last line. In this address period Tw, a gas discharge (erasure address discharge) is produced in a space between the address electrode Dₖ and the transparent electrode Sa shown in FIG. 3 in the discharge cell CL which should be extinguished, and as a result, the wall charge accumulated in the discharge CL is annihilated, thereby setting the discharge cell CL to a non-light emitting mode.

In the next light emission sustain period Ti, the first sustain electrode driver 17A repeatedly applies discharge sustain pulses IP_{L} of negative polarity to the sustain electrodes L₁, . . . , Lₙ₊₁, respectively, a number of times assigned thereto, while the second sustain electrode driver 17B repeatedly applies sustain discharge pulses IP_{S} of negative polarity to the sustain electrodes S₁, . . . , Sₙ, respectively, a number of times assigned thereto. Here, the amplitude of the last discharge sustain pulses IP_{E} applied to the sustain electrodes S₁-Sₙ is set slightly larger, as compared with the previous discharge sustain pulses IP_{S}. As a result, in the discharge cells CL in the light emitting mode, which have the wall charges, a gas discharge (sustain discharge) is produced in a vicinity between a pair of transparent electrodes Sa, La in the main discharge space 60 shown in FIG. 3, and the fluorescent layer 48, which receives ultraviolet rays generated through this discharge, excites to emit light in either R, G, or B.

In the address period Tw of the next subfield SF₂, an erasure address discharge is produced in the discharge cell CL which should be extinguished to annihilate the wall charge. In the next light emission sustain period Ti, the sustain electrode drivers 17A, 17B repeatedly apply the discharge sustain pulses IP_{L}, IP_{S} as mentioned above a number of times assigned thereto. Subsequently, the processing in the subfields SF₃-SF_{M} is performed, as shown in FIG. 4.

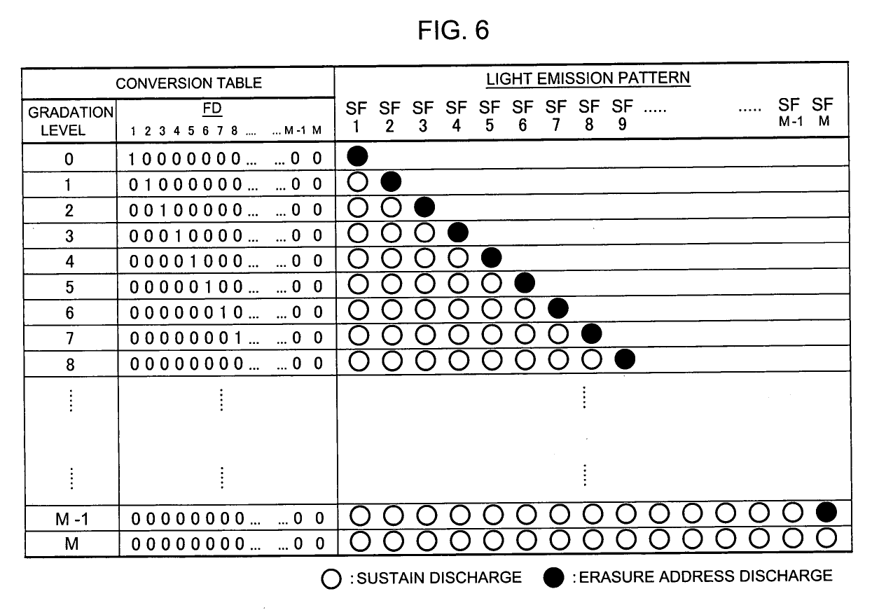

FIG. 6 is a diagram illustrating a correspondence relationship between the gradation level of a corrected video signal PDs and field data FD when the corrected video signal has M+1 gradation levels. The data generator 13 converts a video signal PDs input from the gradation processing unit 12 to M-bit field data FD in accordance with a conversion table shown in FIG. 6, and outputs the field data FD to the frame memory circuit 14. Specifically, when the video signal PDs has a gradation level “0,” the least significant bit (LSB) of the field data FD is set to “1” with the remaining bits thereof set to “0,” respectively. When the video signal PDs has a gradation level “k” (k is an integer from one to M−1), a (k+1)th bit of the field data FD is set to “1” with all the remaining bits set to “0.” Then, when the video signal PDs has a gradation level “M,” all the bits from the least significant bit to the most significant bit (MSB) are set to “0.”

The frame memory circuit 14 reads field data FD temporarily stored therein in units of subfields to output to the address electrode driver 16. The address electrode driver 16 sequentially samples and latches data SD input from the frame memory 14, and then generates an address pulse corresponding to the value of each of bits of the data SD, and applies the address pulse to the address electrodes D₁-Dₘ. In light emission patterns in FIG. 6, the symbol “●” represents the generation of an erasure address discharge, while the symbol “◯” represents the generation of a sustain discharge. According to these light emission patterns, when the field data FD has LSB, the value of which is “1,” an erasure address discharge (“●”) is produced to selectively annihilate wall charges in discharge cells CL, which should be extinguished, in the address period TW of the first subfield SF₁. When the field data FD has a k-th bit, the value of which is “1,” a sustain discharge (“◯”) is produced in those discharge cells CL which have the wall charges in the light emission sustain period Ti of each of the first to (k−1)th subfields SF₁-SFₖ₋₁, and an erasure address discharge (“●”) is produced in the address period Tw of the k-th subfield SFₖ. Then, when the field data FD has all the bits from LSB to MSB, the values of which are “0,” a sustain discharge (“◯”) is produced in the discharge cells CL which have the wall charges in the light emission sustain period Ti of each of all the subfields SF₁-SF_{M}, but no erasure address discharge is produced in the address period Tw.

The foregoing second gradation driving method (hereinafter called the “CLEAR (high Contrast, Low Energy Address and Reduction of false contour) driving method”) requires only one each of the reset discharge and erasure address discharge in each discharge cell CL during a display period of each field, as shown in FIG. 6. Therefore, after the wall charges have been accumulated in all the discharge cells CL of the display panel 2 at the beginning of each field, the light emission pattern of the subfields consistently continues until the wall charges are erased by the erasure address discharge, thereby advantageously eliminating the false contour.

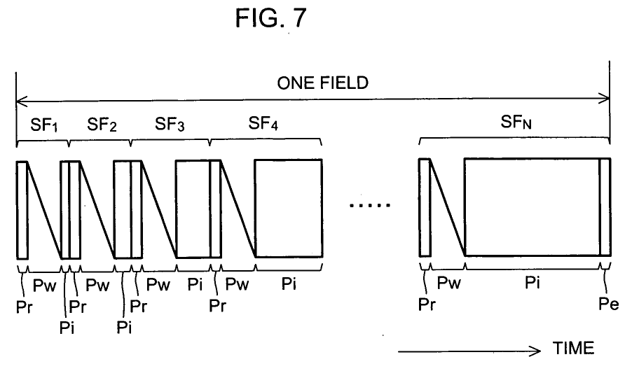

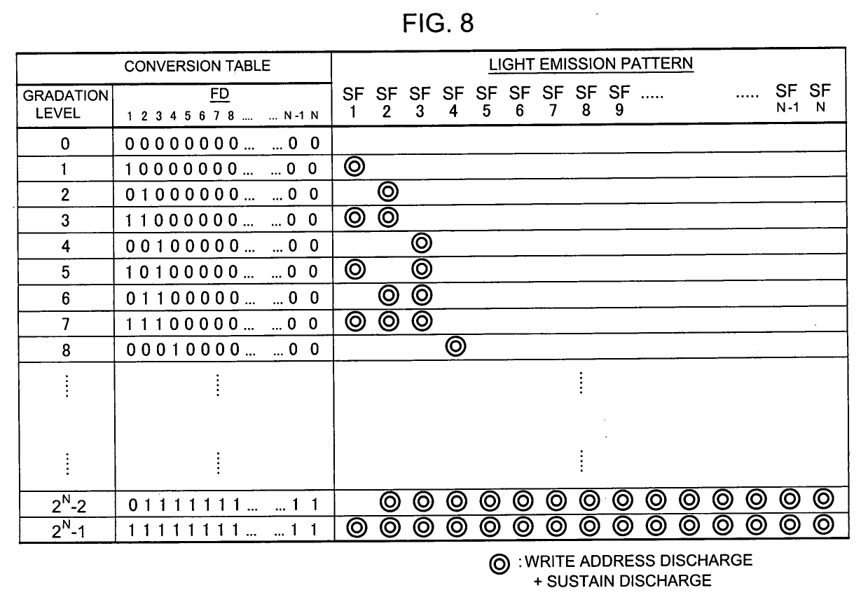

Next, the first gradation driving scheme will be described in brief. The first gradation driving scheme (hereinafter referred to as the “bit driving method”) employs a driving method which sets the ratio (weighting coefficient) of light emission sustain periods assigned to the respective subfields to 2's powers, as described in the aforementioned Japanese Patent Kokai No. 2004-4606. FIG. 7 shows an example of a light emission driving format in accordance with the first gradation driving scheme, and FIG. 8 illustrates a correspondence relationship between the gradation levels of the corrected video signal DPs when the corrected video signal has 2^{N} gradation levels and the field data FD.

Referring to FIG. 7, one field of a video signal is divided into N (N is an integer equal to or more than one) subfields SF₁-SF_{N} arranged in sequence in a displaying order, where each of the subfields SF₁-SF_{N} has a reset period Pr, an address period Pw, and a light emission sustain period Pi. The subfields SF₁, SF₂, SF₃, . . . , SF_{N} are assigned light emission sustain periods Pi which are proportional to 2⁰, 2¹, 2², . . . , 2^{N}, respectively.

In each reset period Pr, the driving control part 23 controls the sustain electrode drivers 17A, 17B to apply reset pulses to the sustain electrodes L₁-Lₙ₊₁, S₁-Sₙ to produce reset discharges in all the discharge cells CL of the display panel 2, resulting in the generation of wall charges therein. Subsequently, the driving control part 23 controls the sustain electrode control unit 23 to apply erasure pulses to the sustain electrodes L₁-Lₙ₊₁, S₁-Sₙ to simultaneously annihilate the wall charges in all the discharge cells CL of the display panel 2. In this way, all the discharge cells CL are initialized to a non-light emitting mode.

Also, in the address period Pw next to the reset period Pr, the first sustain electrode driver 17 sequentially applies a scanning pulse to the sustain electrodes L₁-Lₙ₊₁, while the second sustain electrode driver 17B sequentially applies a scanning pulse to the sustain electrodes S₁-Sₙ. The address electrode driver 16 sequentially applies the address electrodes D₁-Dₘ with an address pulse group synchronized to each scanning pulse. In this way, a write address discharge is produced in discharge cells CL which should be lit, thereby selectively forming wall charges therein.

In the light emission sustain period Pi after the address period Pw, the sustain electrode drivers 17A, 17B repeatedly apply discharge sustain pulses to the sustain electrodes L₁-Lₙ₊₁, S₁-Sₙ respective numbers of times assigned thereto. In this way, a gas discharge (i.e., a sustain discharge) is produced in those discharge cells CL in which the wall charge is accumulated, and the fluorescent layer, which receives ultraviolet rays generated through this discharge, excites to emit light. Then, in the last subfield SF_{N}, the driving control part 23 simultaneously produces an erasure discharge in all the discharge cells CL in the erasure period Pe next to the light emission sustain period Pi to annihilate the wall charges.

The data generator 13 converts the corrected video signal PDs of N-bit gradation, input from the gradation processing unit 12, to field data FD comprised of an N-bit binary signal, which is output to the frame memory 14. Specifically, when the video signal PDs has a gradation level “0,” all the bits of the field data FD from the first least significant bit (LSB) to the N-th most significant bit (MSB) are set to “0.” When the video signal PDs has a gradation level “k” (k is an integer from one to 2^{N}), field data FD having a binary value of the gradation level k is generated. For example, when the gradation level is “3,” the field data FD has the value “000 . . . 011,” and when the gradation level is “2^{N}-1,” the field data FD has the value “111 . . . 111.”

The frame memory circuit 14 reads the field data FD stored therein in units of subfields and outputs the read field data FD to the address electrode driver 16. In each address period Pw, the address electrode driver 16 sequentially samples and latches data SD input from the frame memory circuit 14, then generates address pulses based on a light emission pattern corresponding to the value of the data SD, and applies them to the address electrodes D₁-Dₘ. The light emission patterns corresponding to the respective gradation levels have been determined as shown in FIG. 8. In FIG. 8, the symbol “⊚” represents the occurrences of a write address discharge and a sustain discharge. A combined discharge (“⊚”) of a write address discharge with a sustain discharge is produced in a display period of a subfield in which a discharge cell CL should emit light. For example, a display cell CL emits light in correspondence to a gradation level “3” in a display period of the subfields SF₁, SF₂.

In the foregoing bit driving method, subfields in which the display cells CL emit light do not always continue in one field. For example, referring to FIG. 8, in a light emission pattern corresponding to a gradation level “8,” it is only the subfield SF₄ in which the discharge cells CL emit light, so that referring to the light emission driving format shown in FIG. 7, the discharge cells CL do not emit light during the display periods SF₁, SF₂, SF₃. Therefore, as described above, the bit driving method can advantageously represent a larger number of gradation levels though dynamic false contour can arise.

The inventors noted the fact that when a moving image is displayed in accordance with the bit driving method, an observer hardly views dynamic false contour on a low-luminance image, while the dynamic false contour is easily visible in a high-luminance image. When an image is dark in the whole field, dynamic false contour is made less prominent even if a moving image is displayed under the bit driving method. Conversely, when an image is bright in the whole field, a moving image can be displayed under the aforementioned CLEAR driving method in order to prevent the occurrence of dynamic false contour. The plasma display 1 of this embodiment has a function of setting the number of subfields assigned to the bit driving method and the number of subfields assigned to the CLEAR driving method to values in accordance with a localized luminance distribution of a video signal on a field-by-field basis.

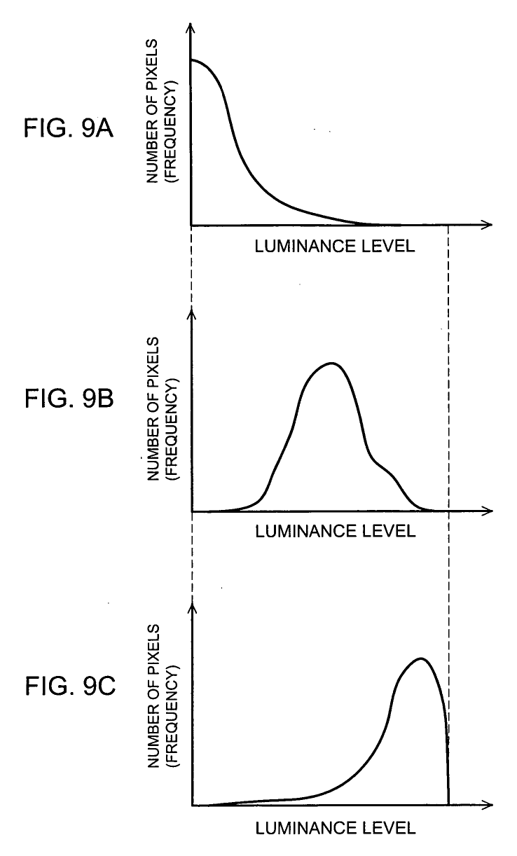

Referring to FIG. 1, the luminance distribution detector 20 detects a luminance distribution, for example, every frame or every predetermined number of frames from a digital video signal DD supplied from the A/D converter 10, and supplies the detected data to the controller 21. FIGS. 9A, 9B, and 9C illustrate luminance histograms representing luminance distributions. FIG. 9A shows a luminance histogram of a digital video signal DD, the luminance distribution of which is localized in a low luminance region; FIG. 9B shows a luminance histogram representing a luminance distribution localized in an intermediate luminance region; and FIG. 9C shows a luminance histogram representing a luminance distribution localized in a high luminance region. The luminance distribution detector 20 supplies the controller 21 with luminance characteristic information indicative of the luminance distribution of a video signal, for example, an average luminance value, a standard deviation value, a variance value, a difference between a maximum luminance value and a minimum luminance value, and the like.

The subfield allocation part 22 determines the degree of deviation or localization in the luminance distribution of the digital video signal DD based on the luminance characteristic information supplied from the luminance distribution detector 20, and divides each field into a first subfield group and a second subfield group in accordance with the result of the determination. The driving control part 23 controls to drive the display panel 2 in accordance with the aforementioned bit driving method in a display period of the first subfield group, and controls to drive the display panel 2 in accordance with the aforementioned CLEAR driving method in a display period of the second subfield group.

Specifically, assuming that the total number of subfields making up each field is a constant value NA (NA is a predetermined positive integer), the number of subfields allocated to the first subfield group is set to N1 (N1 is an integer from zero to NA), while the number of subfields allocated to the second subfield group is set to NA-N1. However, in order to suppress the occurrence of dynamic false contour, the first subfield group is corresponded to lower bits of a video signal PDs, i.e., lower subfields which have shorter light emission sustain periods, while the second subfield group is corresponded to upper bits of the video signal PDs, i.e., upper subfields which have longer light emission sustain periods. As a result, N1 subfields SF₁-SF_{N1} arranged in succession, out of one field, belong to the first subfield group, while the remaining NA-N1 subfields SF_{N1+1}-SF_{NA} belong to the second subfield group.

In this way, when the numbers N1, NA-N1 of subfields are allocated to the first subfield group and the second subfield group, respectively, the number of gradation levels for one field is determined by 2^{N1}+NA-N1. Specifically, the number of gradation levels according to the bit driving method is 2^{N1}, while the number of gradation levels according to the CLEAR driving method is NA-N1+1, so that the number of combined gradation levels amounts to 2^{N1}+NA-N1. The subfield allocation part 22 supplies information on these numbers of gradation levels to the data converter 11, gradation processing unit 12, and data generator 13, and in response, the data converter 11 performs inverse gamma correction on an input signal DD to output a corrected video signal PD having a bit length corresponding to the number of combined gradation levels. For example, when one field has a number of gradation levels equal to 32 (=2⁵), a 5-bit corrected video signal PD is output.

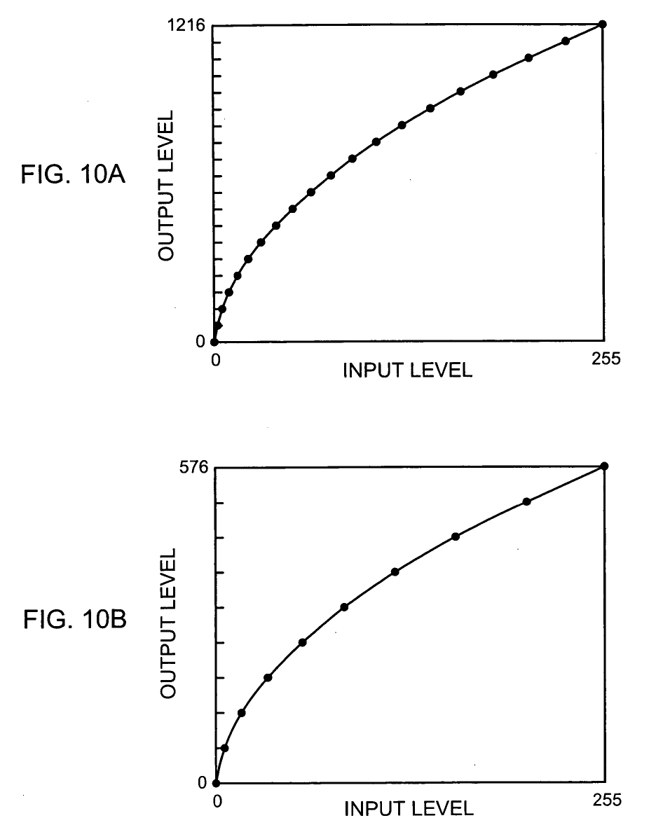

FIGS. 10A and 10B schematically illustrate the input/output characteristic of the data converter 11. In the graphs shown in FIGS. 10A and 10B, respectively, the horizontal axis corresponds to levels (0-255) of an input signal, while the vertical axis corresponds to levels of an output signal. FIG. 10A shows a graph when a corrected video signal PD having 20 gradation levels is output for an input signal, while FIG. 10B shows a graph when a corrected video signal PD having 10 gradation levels is output for an input signal. The following Table 1 shows an input/output relationship as represented in FIG. 10A, while the following Table 2 shows an input/output relationship as represented in FIG. 10B.

TABLE 1

| Input Level | Output Level | Gradation Level |
|---|---|---|
| 0 | 0 | 0 |
| 4 | 64 | 1 |
| 12 | 128 | 2 |
| 20 | 192 | 3 |
| 30 | 256 | 4 |
| 41 | 320 | 5 |
| 52 | 384 | 6 |
| 65 | 448 | 7 |
| 78 | 512 | 8 |
| 91 | 576 | 9 |
| 106 | 640 | 10 |
| 120 | 704 | 11 |
| 135 | 768 | 12 |
| 151 | 832 | 13 |
| 167 | 896 | 14 |
| 183 | 960 | 15 |
| 201 | 1024 | 16 |
| 219 | 1088 | 17 |
| 236 | 1152 | 18 |
| 255 | 1216 | 19 |

TABLE 2

| Input Level | Output Level | Gradation Level |
|---|---|---|
| 0 | 0 | 0 |
| 13 | 64 | 1 |
| 32 | 128 | 2 |
| 57 | 192 | 3 |
| 84 | 256 | 4 |
| 115 | 320 | 5 |
| 147 | 384 | 6 |
| 182 | 448 | 7 |
| 218 | 512 | 8 |
| 255 | 576 | 9 |

Referring to Table 1, for example, when an input signal has a level (input level) equal to or higher than “0” and lower than “3,” an output signal has a level (output level) of “0.” When the input level is equal to or higher than “236” and lower than “255,” the output level is at “1152.” When the input level is at “255,” the output level is at “1216.”

Upon receipt of information on the number of gradation levels for a field from the subfield allocation part 22, the gradation processing unit 12 adaptively executes the error diffusion processing and dither processing in accordance with the number of gradation levels. In this way, even if the data converter 11 outputs a corrected video signal PD of a bit length associated with a small number of gradation levels, the gradation levels of the corrected video signal PD can be virtually interpolated in accordance with the number of gradation levels.

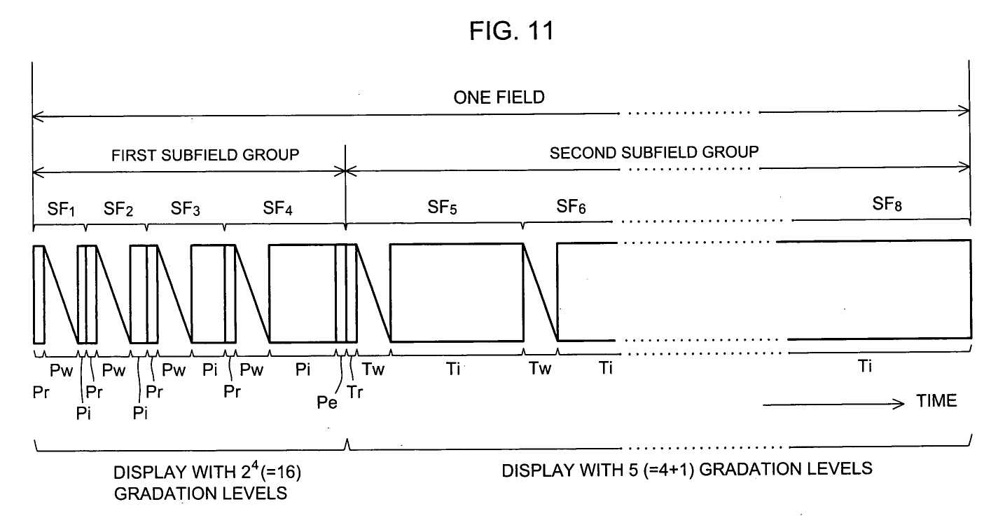

Upon receipt of the information on the number of gradation levels for a field from the subfield allocation part 22, the data generator 13 generates field data FD in accordance with a number of gradation levels according to the bit driving method and a number of gradation levels according to the CLEAR driving method. FIG. 11 illustrates a light emission driving format when a video signal DD presents a luminance distribution which is localized in the low luminance region. Referring to FIG. 11, one field of field data FD is composed of a first subfield group comprised of subfields SF₁-SF₄ displayed in accordance with the bit driving method, and a second subfield group comprised of subfields SF₅-SF₈ displayed in accordance with the CLEAR driving method. The first subfield group is corresponded to lower bits of the field, i.e., lower subfields SF₁-SF₄ which have relatively short light emission sustain periods, while the second subfield group is corresponded to upper bits of the field, i.e., upper subfields SF₅-SF₈ which have relatively long light emission sustain periods. Therefore, considering 16 (=2⁴) gradation levels provided by the bit driving method and five (=4+1) gradation levels provided by the CLEAR driving method, the number of combined gradation levels which can be represented is 20 (=16+5−1) gradation levels.

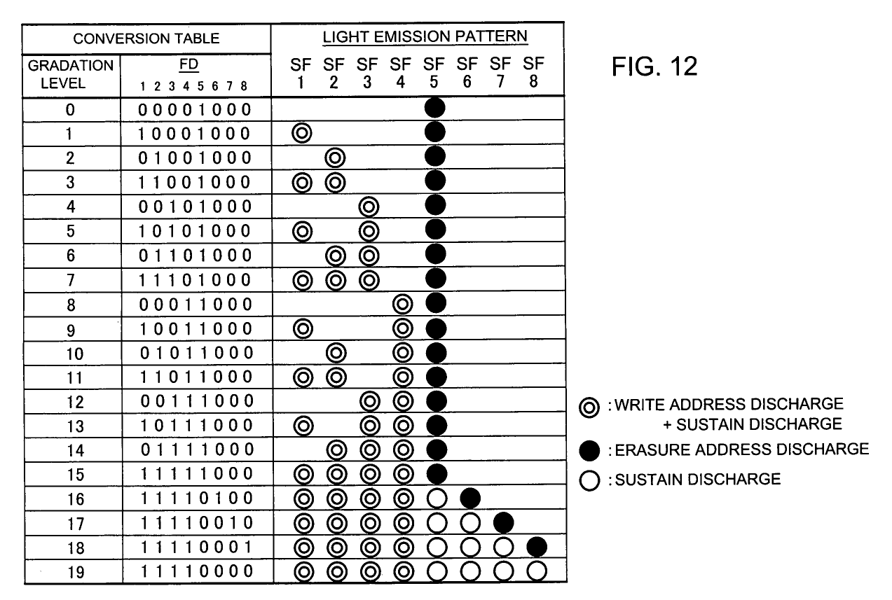

FIG. 12 shows a conversion table and light emission patterns corresponding to the light emission driving format shown in FIG. 11. In the light emission patterns of FIG. 12, the symbol “⊚” represents the occurrence of a write address discharge and a sustain discharge in accordance with the bit driving method; the symbol “◯” represents the occurrence of a sustain discharge in accordance with the CLEAR driving method; and the symbol “●” represents the occurrence of an erasure address discharge in accordance with the CLEAR driving method. As described above, the data generator 13 converts a video signal PDs input from the gradation processing unit 12 to field data FD in accordance with a gradation level of the video signal PDs. According to the conversion table of FIG. 12, for example, the value of the field data corresponding to a gradation level “0” is “00010000”; the value of the field data FD corresponding to a gradation level “1” is “00011110”; and the value of the field data FD corresponding to a gradation level “18” is “10001111.” In this way, lower four bits of the field data FD corresponding to 2⁴ gradation levels are allocated to the bit driving method, while the upper four bits of the field data FD corresponding to five (=4+1) gradation levels are allocated to the CLEAR driving method.

Referring to FIG. 12, in a range of gradation levels “0”-“15,” the subfields SF₁-SF₄ are displayed with multiple gradation levels in accordance with the bit driving method. In a display period of the first subfield SF₅ in the subsequent subfields SF₅-SF₈, an erasure address discharge (“●”) is produced in accordance with the CLEAR driving method to annihilate wall charges of discharge cells CL which should be extinguished. On the other hand, in a range of gradation levels “16”-“19,” in display periods of the subfields SF₁-SF₄, a write address discharge and a sustain discharge are produced in succession in accordance with the bit driving method, and in the subsequent subfields SF₅-SF₈, multiple gradation levels are displayed in accordance with the CLEAR driving method.

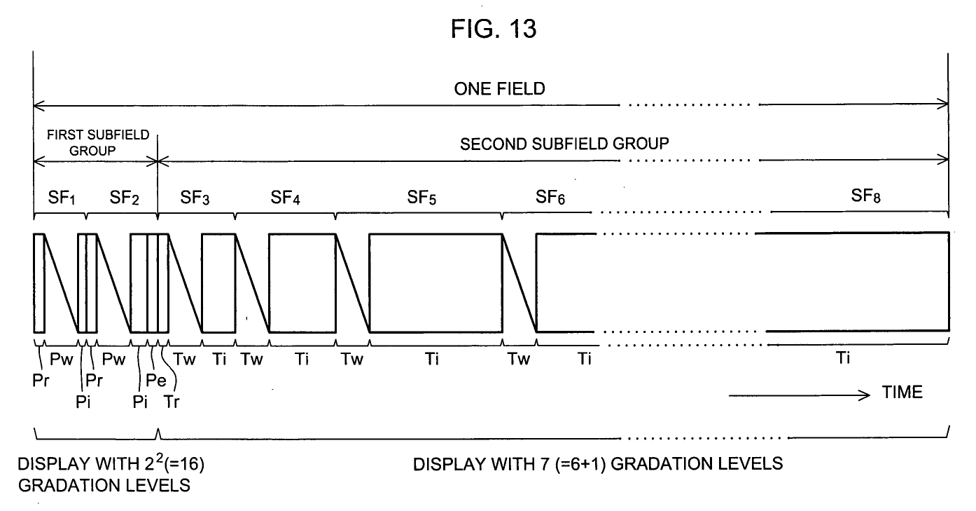

Next, when a video signal DD presents a luminance distribution which is localized in the high luminance region or intermediate luminance region, a light emission driving format shown in FIG. 13 is used. One field of field data FD is composed of a first subfield group comprised of subfields SF₁, SF₂ displayed in accordance with the bit driving method, and a second subfield group comprised of subfields SF₃-SF₈ displayed in accordance with the CLEAR driving method. The first subfield group is corresponded to lower bits of one field, i.e., lower subfields SF₁, SF₂ which have relatively short light emission sustain periods, while the second subfield group is corresponded to upper bits of one field, i.e., upper subfields SF₃-F₈ which have relatively long light emission sustain periods. Therefore, considering four (=2²) gradation levels provided by the bit driving method and seven (6+1) gradation levels provided by the CLEAR driving method, the number of combined gradation levels which can be represented amounts to ten (=4+7−1) gradation levels.

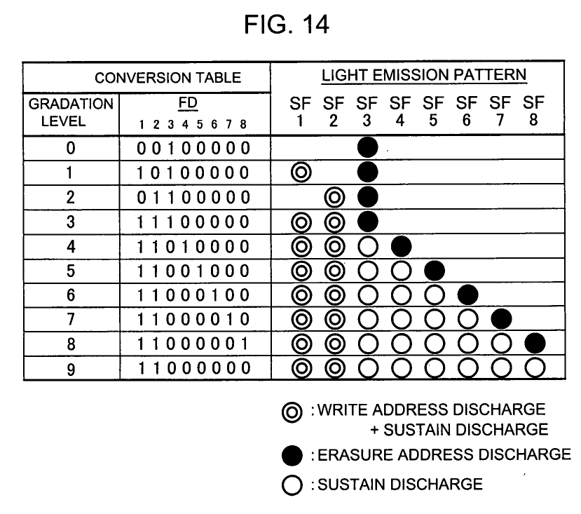

FIG. 14 shows a conversion table and light emission patterns corresponding to the light emission driving pattern shown in FIG. 13. In the light emission pattern of FIG. 14, the symbol “⊚” represents the occurrence of a write address discharge and a sustain discharge in accordance with the bit driving method; a symbol “◯” represents the occurrence of a sustain discharge in accordance with the CLEAR driving method; and the symbol “●” represents the occurrence of an erasure address discharge in accordance with the CLEAR driving method. According to this conversion table, the value of field data FD corresponding to gradation level “0” is “00000100”; the value of field data FD corresponding to gradation level “4” is “00000111”; and the value of field data FD corresponding to gradation level “0” is “10000011.” In this way, the lower two bits of the field data FD corresponding to 2² gradation levels are allocated to the bit driving method, while the upper six bits of the field data FD corresponding to seven (=6+1) gradation levels are allocated to the CLEAR driving method.

Referring to FIG. 14, in a range of the gradation levels “0”-“3,” the subfields SF₁, SF₂ are displayed with multiple gradation levels in accordance with the bit driving method. In the display period of the first subfields SF₃ in the subsequent subfields SF₃-SF₈, an erasure address discharge (“●”) is produced in accordance with the CLEAR driving method to annihilate wall charges of discharge cells CL which should be extinguished. In a range of the gradation levels “4”-“9,” in display periods of the subfields SF₁, SF₂, a write address discharge and a sustain discharge (“⊚”) are produced in succession in accordance with the bit driving method, and the subsequent subfields SF₃-SF₈ are displayed with multiple gradation levels in accordance with the CLEAR driving method.

As described above, when the luminance distribution of a digital video signal DD changes to the distribution localized in the low luminance region (see FIG. 9A), the luminance distribution detector 20 detects such a distribution, and supplies luminance characteristic information to the subfield allocation part 22. Next, the subfield allocation part 22 reduces the number of subfields allocated to the first subfield group, and increases the number of subfields allocated to the second subfield group in accordance with the luminance information to divide one field into the first subfield group and second subfield group as shown in FIG. 11. The driving control part 23 controls to drive the display panel 2 in accordance with the light emission patterns as shown in FIG. 12. Therefore, even if a relatively large number of subfields SF₁-SF₄ are displayed in accordance with the bit driving method, the observer can enjoy viewing a low luminance image displayed with many gradation levels without viewing any dynamic false contour.

When the luminance distribution of the digital video signal DD further deviates from the localized distribution shown in FIG. 9A toward a lower luminance region, the subfield allocation part 22 may further increase the number of subfields allocated to the first subfield group, and further reduce the number of subfields allocated to the second subfield group. When the luminance distribution extremely deviates to a lower luminance region, it is possible to set the number of subfields allocated to the second subfield group to “0.”

On the other hand, when the luminance distribution of a digital video signal DD changes to the distribution localized in the intermediate luminance region (see FIG. 9B) or the distribution localized in the high luminance region (see FIG. 9C), the luminance distribution detector 20 detects such a distribution, and supplies luminance characteristic information to the subfield allocation part 22. Next, the subfield allocation part 22 increases the number of subfields allocated to the first subfield group and reduces the number of subfields allocated to the second subfield group in accordance with the luminance characteristic information to divide one field into the first subfield group and second subfield group, as shown in FIG. 13. The driving control part 23 controls to drive the display panel 2 in accordance with the light emission patterns as shown in FIG. 14. Consequently, since the proportion of the subfields displayed in accordance with the bit driving method, occupied in one filed, is reduced in the extreme, the observer can enjoy viewing a displayed image without substantially viewing dynamic false contour.

When the luminance distribution of the digital video signal DD further deviates from the localized distribution shown in FIG. 9C toward a higher luminance region, the subfield allocation part 22 may further reduce the number of subfields allocated to the first subfield group, and may further increase the number of subfields allocated to the second subfield group. When the luminance distribution extremely deviates to a higher luminance region, it is possible to set the number of subfields allocated to the first subfield group to “0.”

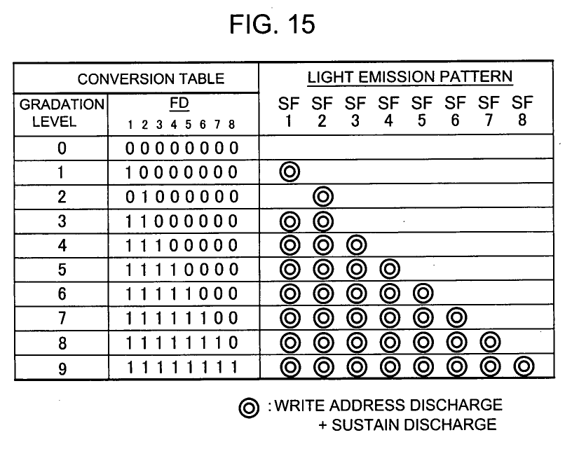

While the foregoing embodiment is configured such that the first subfield group is displayed in accordance with the bit driving method and the second subfield group is displayed in accordance with the CLEAR driving method, there may be an exemplary modification which improves one or both of the CLEAR driving method and bit driving method. FIG. 15 shows exemplary light emission patterns according to a first exemplary modification. Subfields SF₁, SF₂ belongs to a first subfield group, while subfields SF₃-SF₈ belong to a second subfield group. In a range of gradation levels “0”-“3,” the subfields SF₁, SF₂ are displayed with multiple gradation levels in accordance with the bit driving method, and in display periods of the subsequent subfields SF₃-SF₈, the discharge cells CL do not emit light. In a range of gradation levels “4”-“9,” a combined discharge (“⊚”) of a write address discharge and a sustain discharge is produced in accordance with the bit driving method in display periods of the subfields SF₁, SF₂, and the combined discharge (“⊚”) is produced in succession in display periods of the subsequent subfields SF₃-SF₈. In a display period of the second subfield group, since the combined discharge (“⊚”) is consistently produced from start to finish in succession in terms of time, it is possible to largely reduce the occurrence of dynamic false contour as is the case with the CLEAR driving method.

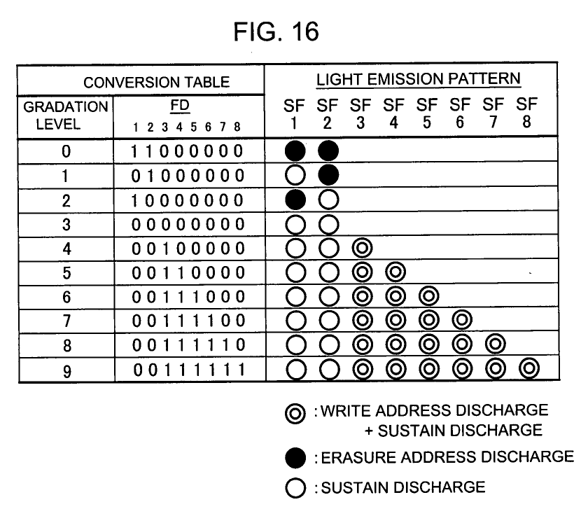

FIG. 16 is a diagram showing exemplary light emission patterns according to a second exemplary modification. Subfields SF₁, SF₂ belong to a first subfield group, while subfields SF₃-SF₈ belong to a second subfield group. In a range of gradation levels “0”-“3,” 24 gradation levels are displayed by a combination of an erasure address discharge (“●”) with a sustain discharge (“◯”) in display periods of the subfields SF₁, SF₂. In display periods of the subsequent subfields SF₃-SF₈, the discharge cells CL do not emit light. Also, in a range of gradation levels “4”-“9,” sustain discharges (“◯”) are produced in succession in display periods of the subfields SF₁, SF₂, and combined discharges (“⊚”) are consistently produced from start to finish in succession in terms of time in display periods of the subsequent subfields SF₃-SF₈. Thus, it is possible to largely reduce the occurrence of dynamic false contour, as is the case with the CLEAR driving method.

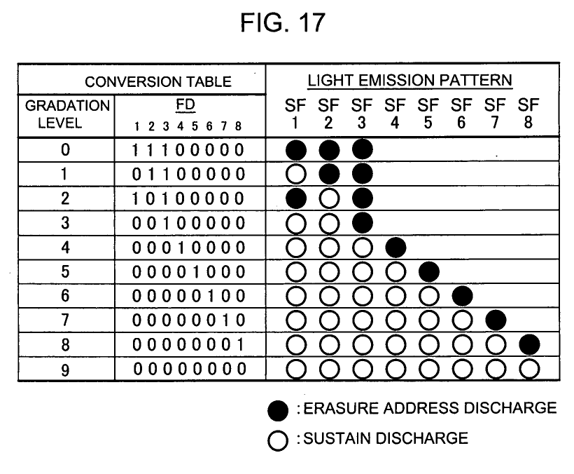

FIG. 17 is a diagram showing exemplary light emission patterns according to a third exemplary modification. Subfields SF₁, SF₂ belong to a first subfield group, while subfields SF₃-SF₈ belong to a second subfield group. In a range of gradation levels “0”-“3,” 2⁴ gradation levels are displayed by a combination of an erasure address discharge (“●”) with a sustain discharge (“0”) in display periods of the subfields SF₁, SF₂. In display periods of the subsequent subfield SF₃, an erasure address discharge (“●”) is produced, and in display periods of the subsequent subfields SF₄-SF₈, the discharge cells CL do not emit light. Also, in a range of gradation levels “4”-“9,” the subfields SF₁-SF₈ are displayed in accordance with the aforementioned CLEAR driving method.

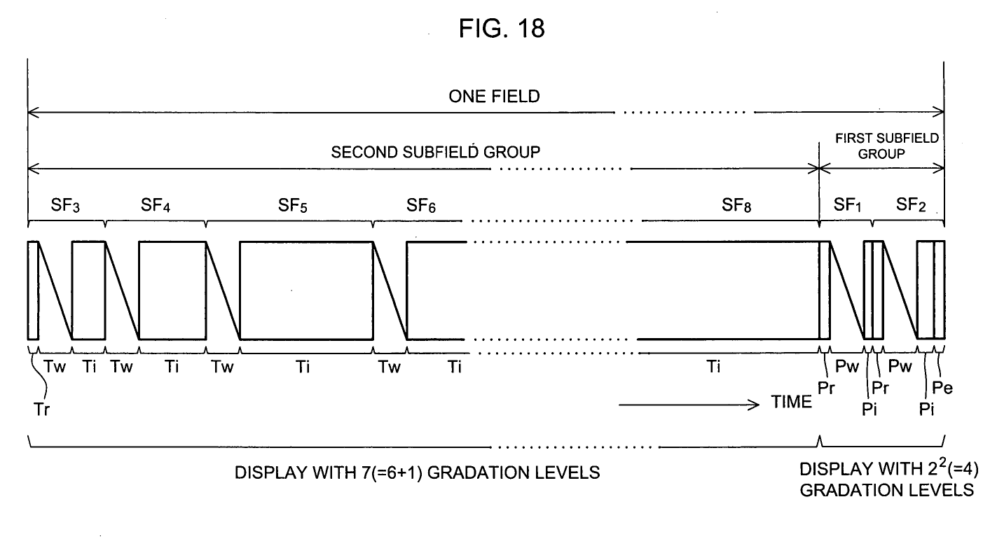

In the foregoing embodiments and exemplary modifications, the first subfield group precedes the second subfield group in each field. Alternatively, the second subfield group may be followed by the first subfield group. For example, as shown in FIG. 18, when the first subfield group is comprised of subfields SF₁, SF₂, the subfields SF₁, SF₂ can be arranged behind the second subfield group.

It is understood that the foregoing description and accompanying drawings set forth the preferred embodiments of the invention at the present time. Various modifications, additions and alternatives will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese Patent Application No. 2004-195988 which is hereby incorporated by reference.

What is claimed is:

1. A method of driving a display panel for displaying a halftone image of each of fields constituting a video signal, each said field being composed of a plurality of subfields, said method comprising the steps of:
(a) detecting a luminance distribution of the video signal;
(b) dividing each of the fields into a first subfield group comprised of N subfields (where N is an integer equal to or more than one), and a second subfield group comprised of M subfields (where M is an integer equal to or more than one);
(c) displaying the first subfield group with 2^{N} gradation levels on said display panel; and
(d) displaying the second subfield group with (M+1) gradation levels on said display panel,
wherein at said step (b), the number N of subfields allocated to the first subfield group and the number M of subfields allocated to the second subfield group are set in accordance with the luminance distribution.

2. A method of driving a display panel according to claim 1, wherein:
said display panel includes a plurality of display cells arranged in a planar fashion, and each of said display cells does not emit light when said display cell is set to a non-light emitting mode in a display period of each of the subfields, and emits light when said display cell is set to a light emitting mode in the display period; and
said step (c) includes the steps of: selecting a combination of subfields making up a light emission sustain period from among subfields belonging to the first subfield group, the light emission sustain period corresponding to a gradation level of said display cell; setting said display cell to the light emitting mode in the selected subfields; and setting said display cell to the non-light emitting mode in the non-selected subfields to drive said display cell.

3. A method of driving a display panel according to claim 1, wherein:
said display panel includes a plurality of display cells arranged in a planar fashion, and each of said display cells does not emit light when said display cell is set to a non-light emitting mode in a display period of each of the subfields, and emits light when said display cell is set to a light emitting mode in the display period; and
said step (d) includes the steps of: selecting successively arranged subfields making up a light emission sustain period from among subfields belonging to the second subfield group, the light emission sustain period corresponding to a gradation level of said display cell; setting said display cell to the light emitting mode in the selected subfields; and setting said display cell to the non-light emitting mode in the non-selected subfields to drive said display cell.

4. A method of driving a display panel according to claim 1, wherein:
said step (a) includes detecting a deviation of the luminance distribution; and
said step (b) includes setting the numbers N and M of subfields in accordance with the deviation of the luminance distribution.

5. A method of driving a display panel according to claim 4, wherein said step (b) includes, when the luminance distribution changes to a distribution localized in a high luminance region or in an intermediate luminance region, reducing the number of subfields allocated to the first subfield group and increasing the number of subfields allocated to the second subfield group.

6. A method of driving a display panel according to claim 4, wherein said step (b) includes, when the luminance distribution changes to a distribution localized in a low luminance region, increasing the number of subfields allocated to the first subfield group and reducing the number of subfields allocated to the second subfield group.

7. A method of driving a display panel according to claim 1, wherein a total number of subfields included in each of the fields is constant.

8. A method of driving a display panel according to claim 1, further comprising the step of performing inverse gamma correction on an input video signal to supply a corrected video signal having a number of gradation levels depending on the numbers N and M of subfields allocated at said step (b),
wherein said step (b) includes dividing each of fields constituting the corrected video signal into the first subfield group and the second subfield group.

9. A method of driving a display panel according to claim 1, wherein at said step (b), said N subfields included in the first subfield group are arranged in succession, and said M subfields included in the second subfield group are arranged in succession.

10. A method of driving a display panel according to claim 1, wherein a plasma display panel is driven.

11. A device for driving a display panel for displaying a halftone image each of fields constituting a video signal, each said field being composed of a plurality of subfields, said device comprising:
a luminance distribution detector for detecting a luminance distribution of the video signal;
a subfield allocation part for dividing each of the fields into a first subfield group comprised of N subfields (N is an integer equal to or more than one), and a second subfield group comprised of M subfields (M is an integer equal to or more than one); and
a driving unit for driving said display panel to display the first subfield group with 2^{N} gradation levels and the second subfield group with (M+1) gradation levels,
wherein said subfield allocation part sets the number N of subfields allocated to the first subfield group and the number M of subfields allocated to the second subfield group in accordance with the luminance distribution.
